(19) United States
(12) Patent Application Publication
(10) Pub. No.: US 2002/0155971 A1
(43) Pub. Date: Oct. 24, 2002

(54) Enzyme tablets for cleaning improvement

(75) Inventors: Mads Aage Laustsen, Lyngby (DK); Charlotte Johansen, Holte (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 09/821,343

(22) Filed: Mar. 29, 2001

Related U.S. Application Data
(60) Provisional application No. 60/195,519, filed on Apr. 6, 2000.
(60) Provisional application No. 60/218,181, filed on Jul. 14, 2000.

(30) Foreign Application Priority Data
Apr. 3, 2000 (DK) 2000 00548
Jul. 7, 2000 (DK) 2000 01063

(51) Int. Cl. C11D 17/00

(52) U.S. Cl. 510/392; 510/444; 510/446; 510/447

(57) ABSTRACT

The present invention concerns an enzyme containing cleaning particle having a size of more than 10.5 mm in its longest dimension, wherein the non-enzyme components of the particle have a detergency of less than 4.

### CROSS-REFERENCE TO RELATED APPLICATIONS

This applications claims priority from Danish application nos. PA 2000 00548 and PA 2000 01063 filed Apr. 3, 2000 and Jul. 7, 2000, respectively, and from U.S. application Ser. Nos. 60/195,519 and 60/218,181 filed Apr. 6, 2000 and Jul. 14, 2000, respectively, the contents of which are fully incorporated herein by reference.

### TECHNICAL FIELD

This invention relates to enzyme products formulated in solid particulate form or in encapsulated liquid form having a size, which enables easy handling and direct application to processes, wherein enzymes are intended to act as catalysts. The invention further relates to a process for producing the enzyme products, to the application of enzyme products and to a package containing the enzyme product.

### BACKGROUND

Enzymes are useful in a number of industries, such as the detergent industry, food and beverage industry, animal feed and pharmaceutical industry.

Important characteristics about enzymes are 1) Enzyme are highly efficient bio-catalysts, 2) enzyme are biological proteins which may cause allergic reactions when exposing humans or animals such as by inhalation, 3) being biological molecules enzymes tend to be inactivated or degraded over time and in order to preserve enzymatic catalysis power they have to be protected from the environment in which they are stored.

Pharmaceutical enzyme products in solid tablet form are known from documents such as JP 4008288 A or U.S. Pat. No. 3,515,642 or WO 95/00121. The enzyme containing tablets disclosed a size of less than 10 mm intended for oral administration.

Enzyme products in solid granular form are known from publications such as Michael S. Showell (editor); Powdered detergents; Surfactant Science Series; 1998; vol. 71; page 140-142; Marcel Dekker. Enzyme granules of the art are spherical and have a diameter of less than 2 mm, because all previously known granules are used as additives to other industrial products such as powder detergents and should be mixable with such compositions. Accordingly much effort has been put into developing enzyme products, which provide protection and stability of the enzyme, when the enzyme product is incorporated and stored in other compositions.

### SUMMARY OF THE INVENTION

The present invention provides in one aspect an enzyme containing cleaning particle having a size of more than 10.5 mm in its longest dimension, wherein the non-enzyme components of the particle have a detergency of less than 4.

In another aspect the invention provides a process for manufacturing the particle of the first aspect and as a third aspect the present invention provides a method for using the particle in a cleaning process.

### DETAILED DESCRIPTION OF THE INVENTION

Definitions

The term “detergency” of a compound or a composition as used in the present application is to be understood as the ability of a composition to remove soiling from a fabric, determined by measuring the amount of light reflected from the fabric (remission) before and after treatment of the fabric with the composition. For the present invention detergency of a compound or a composition is defined as the relative remission value (ΔR) calculated by the formula:

ΔR=R_{buffer+composition}−R_{buffer}

measured on a soiled test swatch fabric washed in a Terg-O-tometer™ at the following conditions:

(a) washing time: 20 minutes,

(b) temperature: 30° C.,

(c) agitation speed: 100 RPM

(d) test swatch: 9 by 5 cm EMPA 116 swatch soiled with blood, milk and carbon black, Swiss Federal Laboratories for Materials Testing and Research, Mövenstrasse 12 CH-9015 St. Gallen, Switzerland.

(e) measurement wavelength: 460 nm

(f) washing solutions: 1) 0.05 M aqueous glycin buffer having a water hardness of 15° dH and a pH of 10, 2) 7.15 g/l test composition in the aqueous glycin buffer.

(g) sample volume: 1000 ml.

The Particle

We have found that commercially available enzyme containing products of today, such as detergents, that contains several enzymes in granular form or dissolved in a liquid, the enzymes are present in amounts, giving a calculated cleaning effect on different types of soiling. This means, that if for example an item to be cleaned is heavily soiled with e.g. a starch based soil more starch hydrolysing enzyme, such as amylase, is needed to achieve a satisfactory cleaning effect. Accordingly more detergent per volume of wash liquor is needed, but by adding more detergent also surpluses of other enzymes (and other cleaning ingredients) such as proteases, cellulases and/or lipases are added to the process without achieving any additional cleaning benefit.

Accordingly we have found that an enzyme may advantageously be added separately from the detergent and directly to the cleaning or washing process. This may naturally also be applied for other processes where enzymes have a useful effect. By separating the enzyme product from the rest of e.g. a detergent composition, the following non limiting list of advantages may be achieved:

a) Different enzymes may be added only in needed amounts to a cleaning process. As enzymes are one of the more expensive parts of a detergent composition this provides an economical benefit as well as providing an optimal cleaning benefit.

b) By keeping and/or storing enzyme products separate from other detergent components such as surfactants, bleaches, builders, improvement in enzyme storage stability is provided.

c) When formulating enzyme products for use separately from other detergent components considerable production benefits are achieved: Addition of expensive formulation additives such as enzyme stabilizers, e.g. antioxidants may be omitted or reduced.

d) It is possible to include higher amounts of enzyme into the individual particle.

e) It is easier to provide precise enzyme dosage to the process in which the enzyme is used.

f) The safety in handling enzymes is improved.

Accordingly there is a need for an enzyme product suitable for applying directly to e.g. a washing process which is easy to handle by a user as well as easy to dose in proper amounts to a washing process. As mentioned supra our invention provides an enzyme containing cleaning particle having a size of more than 10.5 mm in its longest dimension, wherein the non-enzyme components of the particle have a detergency of less than 4. Accordingly the particle of the invention is not a detergent particle as known in the art, such as dish or laundry washing tablets, because in the particle of the invention the enzyme is the only significantly detersive compound. The remaining components of the particle have no or insignificant detergency, as the function of these compounds is to provide acceptable structural, mechanical and chemical stability or enhancement to the particle and the enzyme.

Particle Size

The enzyme containing particle of the invention has a dimension of more than 10.5 mm, in its longest dimension. This technical feature is important for several reasons: Firstly it is important that the particle have a size, which makes oral ingestion humans or animals difficult or impossible. As the particle of the invention is intended for use in the household, it is an important safety issue, that e.g. children may not be able of accidentally swallowing the particle. As known from pharmaceutical disclosures, pharmaceutical tablet sizes of maximum 10.5 mm in diameter are reported used for tablets suitable for oral administration to humans. Accordingly the particle of the invention should have a size of more than 10.5 mm in its longest dimension, preferably between 15 mm and 100 mm, more preferably between 20 mm and 75 mm and most preferably between 20 mm to 50 mm. A further advantage of the minimum particle size is, that as the particles of the invention should be suitable for use as a discrete and directly applicable process additive for e.g. a washing process, a certain minimum size is required for easy handling of the particles. It is contemplated that a user of the particles should be able of, e.g. manually, adding a particle of the invention containing a fixed amount of a required enzyme activity to the desired process, e.g. a washing process, such as by picking up the particle by hand and putting in a washing machine. This is easier done when the particle of the invention has a certain minimum size as outlined supra.

Particle Volume

In a specific embodiment the particle should also have a volume of more than 0.5 cm³, to meet the requirements for an easy handling. Thus in this embodiment a preferred particle volume is more than 1.75 cm³ e.g. more than 4 cm³. Specific useful ranges are between about 0.6 cm³ to about 125 cm³, e.g. between about 1.75 cm³ to about 64 cm³, such as about 4 cm³ to about 27 cm³.

Particle Shape

Also the particle should also have a shape useful for the application and handling. Useful shapes are spheres, ellipsoids, tetra-, penta-, hexa-, hepta- and octahedrons or higher geometrical shapes. Particularly useful and preferred hexahedrons are cube and bar shapes.

Particle Composition

The particle of the invention comprises an enzyme. The enzyme in the context of the invention may be any enzyme or combination of different enzymes. Accordingly, when reference is made to “an enzyme” this will in general be understood to include combinations of one or more enzymes.

It is to be understood that enzyme variants (produced, for example, by recombinant techniques) are included within the meaning of the term “enzyme”. Examples of such enzyme variants are disclosed, e.g., in EP 251,446 (Genencor), WO 91/00345 (Novo Nordisk), EP 525,610 (Solvay) and WO 94/02618 (Gist-Brocades NV).

The enzyme classification employed in the present specification with claims is in accordance with Recommendations (1992) of the Nomenclature Committee of the International Union of Biochemistry and Molecular Biology, Academic Press, Inc., 1992.

Accordingly the types of enzymes which may appropriately be incorporated in granules of the invention include oxidoreductases (EC 1.-.-.-), transferases (EC 2.-.-.-), hydrolases (EC 3.-.-.-), lyases (EC 4.-.-.-), isomerases (EC 5.-.-.-) and ligases (EC 6.-.-.-).

Preferred oxidoreductases in the context of the invention are peroxidases (EC 1.11.1), laccases (EC 1.10.3.2) and glucose oxidases (EC 1.1.3.4)], while preferred transferases are transferases in any of the following subclasses:

a) Transferases transferring one-carbon groups (EC 2.1);

b) transferases transferring aldehyde or ketone residues (EC 2.2); acyltransferases (EC 2.3);

c) glycosyltransferases (EC 2.4);

d) transferases transferring alkyl or aryl groups, other that methyl groups (EC 2.5); and

e) transferases transferring nitrogenous groups (EC 2.6).

A most preferred type of transferase in the context of the invention is a transglutaminase (protein-glutamine γ-glutamyltransferase; EC 2.3.2.13).

Further examples of suitable transglutaminases are described in WO 96/06931 (Novo Nordisk A/S).

Preferred hydrolases in the context of the invention are: Carboxylic ester hydrolases (EC 3.1.1.-) such as lipases (EC 3.1.1.3); phytases (EC 3.1.3.-), e.g. 3-phytases (EC 3.1.3.8) and 6-phytases (EC 3.1.3.26); glycosidases (EC 3.2, which fall within a group denoted herein as “carbohydrases”), such as α-amylases (EC 3.2.1.1); peptidases (EC 3.4, also known as proteases); and other carbonyl hydrolases].

In the present context, the term “carbohydrase” is used to denote not only enzymes capable of breaking down carbohydrate chains (e.g. starches) of especially five- and six-membered ring structures (i.e. glycosidases, EC 3.2), but also enzymes capable of isomerising carbohydrates, e.g. six-membered ring structures such as D-glucose to five-membered ring structures such as D-fructose.

Carbohydrases of relevance include the following (EC numbers in parentheses):

α-amylases (3.2.1.1), β-amylases (3.2.1.2), glucan 1,4-α-glycosidases (3.2.1.3), cellulases (3.2.1.4), endo-1,3(4)-β-glucanases (3.2.1.6), endo-1,4-β-xylanases (3.2.1.8), dextranases (3.2.1.11), chitinases (3.2.1.14), polygalacturonases (3.2.1.15), lysozymes (3.2.1.17), β-glucosidases (3.2.1.21), α-galactosidases (3.2.1.22), β-galactosidases (3.2.1.23), amylo-1,6-glucosidases (3.2.1.33), xylan 1,4-β-xylosidases (3.2.1.37), glucan endo-1,3-β-D-glucosidases (3.2.1.39), α-dextrin endo-1,6-α-glucosidases (3.2.1.41), sucrose α-glucosidases (3.2.1.48), glucan endo-1,3-α-glucosidases (3.2.1.59), glucan 1,4-β-glucosidases (3.2.1.74), glucan endo-1,6-β-glucosidases (3.2.1.75), arabinan endo-1,5-α-L-arabinosidases (3.2.1.99), lactases (3.2.1.108), chitosanases (3.2.1.132) and xylose isomerases (5.3.1.5).

Examples of commercially available oxidoreductases (EC 1.-.-.-) include Gluzyme™ (enzyme available from Novo Nordisk A/S). Further oxidoreductases are available from other suppliers.

Examples of commercially available proteases (peptidases) include Kannase™, Everlase™, Esperase™, Alcalase™, Neutrase™, Durazym™, Savinase™, Pyrase™, Pancreatic Trypsin NOVO (PTN), Bio-Feed™ Pro and Clear-Lens™ Pro (all available from Novo Nordisk A/S, Bagsvaerd, Denmark).

Other commercially available proteases include Maxatase™, Maxacal™, Maxapem™, Opticlean™ and Purafect™ (available from Genencor International Inc. or Gist-Brocades).

Examples of commercially available lipases include Lipoprime™ Lipolase™, Lipolase™ Ultra, Lipozyme™, Palatase™, Novozym™ 435 and Lecitase™ (all available from Novo Nordisk A/S).

Other commercially available lipases include Lumafast™ (Pseudomonas mendocina lipase from Genencor International Inc.); Lipomax™ (Ps. pseudoalcali genes lipase from Gist-Brocades/Genencor Int. Inc.; and Bacillus sp. lipase from Solvay Enzymes).

Examples of commercially available carbohydrases include Alpha-Gal™, Bio-Feed™ Alpha, Bio-Feed™ Beta, Bio-Feed™ Plus, Bio-Feed™ Plus, Novozyme™ 188, Celluclast™, Cellusoft™, Ceremyl™, Citrozym, Denimax™, Dezyme™, Dextrozyme™, Finizym™, Fungamyl™, Gamanase™, Glucanex™, Lactozym™, Maltogenase™, Pentopan™, Pectinex™, Promozyme™, Pulpzyme™, Novamyl™, Termamyl™, AMG™ (Amyloglucosidase Novo), Maltogenase™, Sweetzyme™ and Aquazym™ (all available from Novo Nordisk A/S). Further carbohydrases are available from other suppliers.

The amount of enzyme to be incorporated in a particle of the invention will depend on the intended use of the particle. In the context of the invention, the enzyme contents in particles of the invention is higher, preferably much higher than the enzyme contents of known enzyme containing particles used e.g. as detergent additives. For many applications, the enzyme content will be as high as possible or practicable. The content of enzyme (calculated as pure enzyme protein) in a particle of the invention will typically be at least 0.05% by weight of the particle. Preferably the enzyme protein contents will be in the range of 0.5-75% w/w, more preferably between 1-50% w/w, most preferably between 2-50% w/w, e.g. between 10-50% w/w.

The particle of the invention may however also contain other useful components such as the non-limiting list of binders, fibres, polymers, colorants, perfumes, liquid agents, fillers, bursting agents, enzyme stabilizers, enzyme mediators/cofactors/enhancers and/or enzyme activators and de-activators, solvents and glazing agents.

Examples of useful binders are binders with a high melting point or no melting point at all and of a non waxy nature e.g. polyvinyl pyrrolidon, dextrins, polyvinylalkohol, cellulose derivatives, for example hydroxypropyl cellulose, methyl cellulose or CMC. A suitable binder is a carbohydrate binder such as Glucidex 21D available from Roquette Freres, France. Also starch, starch derivatives and HPMC such as Tackidex® G155, Avedex® 28LA21 and Avebe® W80.

Examples of fibres materials are pure or impure cellulose in fibrous form such as sawdust, pure fibrous cellulose, cotton, or other forms of pure or impure fibrous cellulose. Also, filter aids based on fibrous cellulose can be used. Several brands of cellulose in fibrous form are on the market, e.g. CEPO and ARBOCELL. In a publication from Svenska Trämjolsfabrikerna AB, “Cepo Cellulose Powder” it is stated that for Cepo S/20 cellulose the approximate maximum fibre length is 500 μm, the approximate average fibre length is 160 μm, the approximate maximum fibre width is 50 μm and the approximate average fibre width is 30 μm. Also, it is stated that CEPO SS/200 cellulose has an approximate maximum fibre length of 150 μm, an approximate average fibre length of 50 μm, an approximate maximum fibre width of 45 μm and an approximate average fibre width of 25 μm. Cellulose fibres with these dimensions are very well suited for the purpose of the invention. The words “Cepo” and “Arbocel” are Trade marks. A preferred fibrous cellulose is Arbocel™ BFC200. Also synthetic fibres may be used as described in EP 304331 B1 and typical fibres may be made of polyethylene, polypropylene, polyester, especially nylon, polyvinyl format, poly(meth)acrylic compounds.

Examples of useful polymers are PVP, starch, dextrins, PEG's such as PEG 4000.

Examples of Useful Colorants are TiO₂

Examples of useful liquid agents are water and/or a waxy substance. The liquid agent is always used in a liquid phase in the process of manufacturing the particle of the invention but may later on solidify; the waxy substance if present, therefore, is either dissolved or dispersed in the water or melted. By the term “waxy substance” as used herein is meant a substance which possesses all of the following characteristics 1) the melting point is between 30 and 100° C., preferably between 40 and 60° C., 2) the substance is of a tough and not brittle nature, and 3) the substance possesses a certain plasticity at room temperature. Examples of waxy substances are polyglycols, fatty alcohols, ethoxylated fatty alcohols, mono-, di- and triglycerolesters of higher fatty, acids, e.g. glycerol monostearate, alkylarylethoxylates, and coconut monoethanolamide.

Examples of useful fillers are water soluble and/or insoluble organic or inorganic salts such as finely ground alkali sulphate, alkali carbonate and/or alkali chloride), clays such as kaolin (e.g. Speswhite™, English China Clay), bentonites, talcs, zeolites, and/or silicates.

Examples of useful bursting agents are salts of bicarbonate. These components provides a fast dissolution or dispersion of the particle components in aqueous solution as they in contact with water and provided sufficient acidity develops CO₂ gas which disrupts the particle integrity thus providing increase water access into the particle and swift dissolution of the enzyme. Also organic or inorganic compounds which in contact with water expands or release gases such as starch or starch glucolates or C₃-C₄ dicarboxylic acids or citric acid.

Examples of useful enzyme stabilizers fall into several categories: alkaline or neutral materials, reducing agents, antioxidants and/or salts of first transition series metal ions. Each of these may be used in conjunction with other protective agents of the same or different categories. Examples of alkaline protective agents are alkali metal silicates, -carbonates or bicarbonates which provide a chemical scavenging effect by actively neutralizing e.g. oxidants. Examples of reducing protective agents are salts of sulphite, thiosulphite or thiosulfate, while examples of antioxidants are methionin, butylated hydroxytoluene (BHT) or butylated hydroxyanisol (BHA). Most preferred agents are salts of thiosulphates, e.g. sodium thiosulfate. Also enzyme stabilizers may be borates, borax, formates, di- and tricarboxylic acids and reversible enzyme inhibitors such as organic compounds with sulfhydryl groups or alkylated or arylated boric acids.

Examples of useful enhancers are various organic enhancers acting as electron donors for oxidoreductases for various purposes such as enhancing oxidation in processes of bleaching, coloring and/or providing antimicrobial effect. Various organic enhancers acting as electron donors for oxidoreductases for various purposes are known to the art (e.g. from WO 94/12620, WO 94/12621, WO 95/01626 and WO 96/00179) and may suitably be employed in accordance with this invention.

One group of preferred organic enhancers is phenolic compounds (alkylsyringates) of the formula:

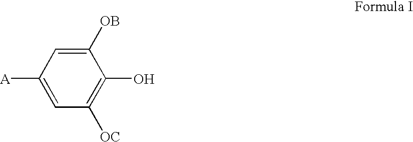

wherein the letter A in said formula denotes be a group such as -D, —CH═CH-D, —CH═CH—CH═CH-D, —CH═N-D, —N═N-D, or —N═CH-D, in which D is selected from the group consisting of —CO-E, —SO₂-E, —N-XY, and —N⁺—XYZ, in which E may be —H, —OH, —R, or —OR, and X and Y and Z may be identical or different and selected from —H and —R; R being a C₁-C₆ alkyl, preferably a C₁-C₈ alkyl, which alkyl may be saturated or unsaturated, branched or unbranched and optionally substituted with a carboxy, sulpho or amino group; and B and C may be the same or different and selected from CₘH₂ₘ₊₁, where m=1, 2, 3, 4 or 5.

In the above mentioned formula A may be placed meta to the hydroxy group instead of being placed in the para-position as shown.

In particular embodiments of the invention the enhancer is selected from the group having the formula:

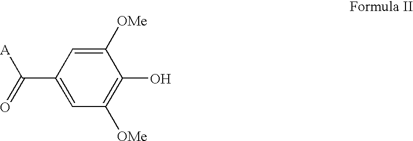

in which A is a group such as —H, —OH, —CH₃, —OCH₃, —O(CH₂)ₙCH₃, where n=1, 2, 3, 4, 5, 6, 7 or 8.

Such enhancers may suitably be present in the particle of the invention in amounts suitable for providing between 0.00001-500 millimole enhancer/kg in the composition to which the particle of the invention is applied, preferably 0.0001-5 millimole/kg, e.g. 0.001-0.050 millimole/kg.

Another preferred group of well performing organic enhancers comprises a —CO—NOH— group and have the following formula:

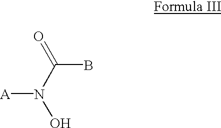

in which A is:

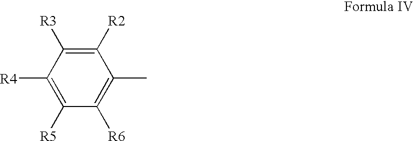

and B is the same as A, or B is H, or C1-C16 branched or unbranched alkyl wherein said alkyl may contain hydroxy, ether or ester groups, and R2, R3, R4, R5 and R6 are H, OH, NH2, COOH, SO3H, C1-C12 branched or unbranched alkyl, acyl, NO2, CN, Cl, CF3, NOH—CO-phenyl, C1-C6-CO—NOH-A, CO—NOH-A, COR12, phenyl-CO—NOH-A, OR7, NR8R9, COOR10, or NOH—CO—R11, wherein R7, R8, R9, R10 and R11 are C1-C12 branched or unbranched alkyl or acyl. Within this group of enhancers particularly preferred enhancers are selected from the group consisting of

4-nitrobenzoic acid-N-hydroxyanilide;

4-methoxybenzoic acid-N-hydroxyanilide;

N,N′-dihydroxy-N,N′-diphenylterephthalamide;

decanoic acid-N-hydroxyanilide;

N-hydroxy-4-cyanoacetanilide;

N-hydroxy-4-acetylacetanilide;

N-hydroxy-4-hydroxyacetanilide;

N-hydroxy-3-(N′-hydroxyacetamide)acetanilide;

4-cyanobenzoic acid-N-hydroxyanilide;

N-hydroxy-4-nitroacetanilide; and

N-hydroxyacetanilide.

Such enhancers may suitably be present in the particle of the invention in amounts suitable for providing between 1-1000 micromole enhancer/kg in the composition to which the particle of the invention is applied, preferably 5-500 micromole/kg.

The enhancer may also be one of the compounds disclosed in WO 96/18770 such as N-hydroxy compounds, in particular aliphatic, cycloaliphatic, heterocyclic or aromatic compounds containing NO—, N(OH)—, or N(OH) (RI), especially N-hydroxy benzotriazol (HOBT), Violuric acid, or N-hydroxyacetanilide (HAA).

In a preferred embodiment of the invention the enhancer is a compound of the general formula (V):

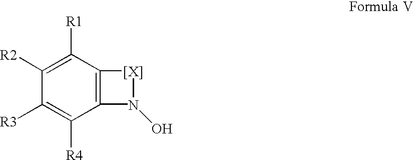

wherein R¹, R², R³, R⁴ are individually selected from the group consisting of hydrogen, halogen, hydroxy, formyl, carboxy and salts and esters thereof, amino, nitro, C₁-C₁₂ alkyl, C₁-C₆ alkoxy, carbonyl (C₁-C₁₂ alkyl), aryl, in particular phenyl, sulpho, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁-C₁₂ alkyl, C₁-C₆ alkoxy, carbonyl (C₁-C₁₂ alkyl) , aryl, in particular phenyl, sulpho, aminosulfonyl, carbamoyl, phosphono, phosphonooxy, and salts and esters thereof, [X] represents a group selected from (—N═N—), (—N═CR⁶—)ₘ, (—CR⁶═N—)ₘ, (—CR⁶═CR⁷—)ₘ, (—CR⁶═N—NR⁷—), (—N═N—CHR⁶—), (—N═CR⁶—NR⁷—) , (—N═CR⁶—CHR⁷—) , (—CR⁶═N—CHR⁷—), (—CR⁶═CR⁷—NR⁸—), and (—CR⁶═CR⁷—CHR⁸—), wherein R⁶, R⁷, and R⁸ independently of each other are selected from H, OH, NH₂, COOH, SO₃H, C₁₋₆-alkyl, NO₂, CN, Cl, Br, F, CH₂OCH₃, OCH₃, COOCH₃; and m is 1 or 2.

In a more preferred embodiment of the invention the enhancer is a compound of the general formula (VI):

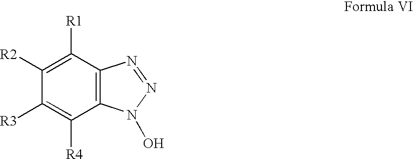

wherein R¹, R², R³, R⁴ are individually selected from the group consisting of hydrogen, halogen, hydroxy, formyl, carboxy and salts and esters thereof, amino, nitro, C₁-C₁₂ alkyl, C₁-C₆ alkoxy, carbonyl(C₁-C₁₂ alkyl), aryl, in particular phenyl, sulpho, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁-C₁₂ alkyl, C₁-C₆ alkoxy, carbonyl(C₁-C₁₂ alkyl), aryl, in particular phenyl, sulpho, aminosulfonyl, carbamoyl, phosphono, phosphonooxy, and salts and esters thereof.

The enhancer may also be a salt or an ester of formula V or VI.

Further preferred enhancers are oxoderivatives and N-hydroxy derivatives of heterocyclic compounds and oximes of oxo- and formyl-derivatives of heterocyclic compounds, said heterocyclic compounds including five-membered nitrogen-containing heterocycles, in particular pyrrol, pyrazole and imidazole and their hydrogenated counterparts (e.g. pyrrolidine) as well as triazoles, such as 1,2,4-triazole; six-membered nitrogen-containing heterocycles, in particular mono-, di- and triazinanes (such as piperidine and piperazine), morpholine and their unsaturated counterparts (e.g. pyridine and pyrimidine); and condensed heterocycles containing the above heterocycles as substructures, e.g. indole, benzothiazole, quinoline and benzoazepine.

Examples of preferred enhancers from these classes of compounds are pyridine aldoximes; N-hydroxypyrrolidinediones such as N-hydroxysuccinimide and N-hydroxyphthalimide; 3,4-dihydro-3-hydroxybenzo[1,2,3]triazine-4-one; formaldoxime trimer (N,N′,N″-trihydroxy-1,3,5-triazinane); and violuric acid (1,3-diazinane-2,4,5,6-tetrone-5-oxime).

Still further enhancers which may be applied in the invention include oximes of oxo- and formyl-derivatives of aromatic compounds, such as benzoquinone dioxime and salicylaldoxime (2-hydroxybenzaldehyde oxime), and N-hydroxyamides and N-hydroxyanilides, such as N-hydroxyacetanilide.

Preferred enhancers are selected from the group consisting of 1-hydroxybenzotriazole; 1-hydroxybenzotriazole hydrate; 1-hydroxybenzotriazole sodium salt; 1-hydroxybenzotriazole potassium salt; 1-hydroxybenzotriazole lithium salt; 1-hydroxybenzotriazole ammonium salt; 1-hydroxybenzotriazole calcium salt; 1-hydroxybenzotriazole magnesium salt; and 1-hydroxybenzotriazole-6-sulphonic acid.

A particularly preferred enhancer is 1-hydroxybenzotriazole.

All the specifications of N-hydroxy compounds above are understood to include tautomeric forms such as N-oxides whenever relevant.

In particular, the enhancer of the invention may be the corresponding N-oxyl free radical to any of the compounds disclosed in WO 96/18770 such as TEMPO (2,2,6,6-tetramethylpiperidinoxyl).

Such enhancers may suitably be present in the particle of the invention in amounts suitable for providing between 1-1000 micromole enhancer/kg in the composition to which the particle of the invention is applied, preferably 5-500 micromole/kg.

Inorganic enhancers may also be relevant. Especially when using haloperoxidases for animal litter compositions presence of inorganic halide ions such as chloride, bromide and/or iodide may enhance the antimicrobial effect of the haloperoxidase. Suitable ranges of chloride ions in the composition to which the particle of the invention is applied are 0.05-500 millimole/kg and suitable ranges of bromide and/or iodide ions are 0.01-100 millimole/kg.

We have further observed that an improved anti-microbial or preservation effect may be obtained using an ammonium enhancer, preferably in combination with a halide enhancer or an organic enhancer. The ammonium enhancer may be compounds of the formula:

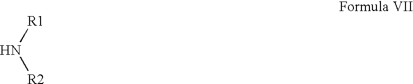

wherein the substituent groups R1 and R2 may be identical or different. R1 and R2 may suitably be any of the following groups: hydrogen, halide, sulphate, phenyl, a straight or branched chain alkyl having from 1 to 14 carbon atoms, or a substituted straight or branched alkyl group having from 1 to 14 carbon atoms where the substituent group is located at C₁-C₁₄ and represent any of the following radicals: hydroxy, halogen, formyl, carboxy, carboxy esters, carboxy salts, carbamoyl, sulfo, sulfo esters, sulfo salts, sulfamoyl, nitro, amino, phenyl, C₁-C₅-alkoxy, carbonyl-C₁-C₅-alkyl, aryl-C₁-C₅-alkyl. Where R1 and/or R2 includes groups selected from carbamoyl, sulfamoyl, and amino groups these groups may furthermore be unsubstituted or substituted once or twice with a substituent group R3. Where R1 and/or R2 includes a phenyl group it may furthermore be unsubstituted or substituted with one or more substituent groups R3. Where R1 and/or R2 includes groups selected from C₁-C₅-alkoxy, carbonyl-C₁-C₅-alkyl, and aryl-C₁-C₅-alkyl these groups may be saturated or unsaturated, branched or unbranched, and may furthermore be unsubstituted or substituted with one or more substituent groups R3. R3 represents any of the following groups: halogen, hydroxy, formyl, carboxy, carboxy esters, carboxy salts, carbamoyl, sulfo, sulfo esters, sulfo salts, sulfamoyl, nitro, amino, phenyl, aminoalkyl, piperidino, piperazinyl, pyrrolidin-1-yl, C₁-C₅-alkyl, C₁-C₅-alkoxy. Where R3 includes groups selected from carbamoyl, sulfamoyl, and amino these groups may furthermore be unsubstituted or substituted once or twice with hydroxy, C₁-C₅-alkyl, C₁-C₅-alkoxy. Where R3 includes phenyl this group may furthermore be substituted with one or more of the following groups: halogen, hydroxy, amino, formyl, carboxy, carboxy esters, carboxy salts, carbamoyl, sulfo, sulfo esters, sulfo salts, and sulfamoyl. Where R3 includes groups selected from C₁-C₅-alkyl, and C₁-C₅-alkoxy these groups may furthermore be saturated or unsaturated, branched or unbranched, and may furthermore be substituted once or twice with any of the following radicals: halogen, hydroxy, amino, formyl, carboxy, carboxy esters, carboxy salts, carbamoyl, sulfo, sulfo esters, sulfo salts, and sulfamoyl. R1 and R2 may also suitably together a group -B-, in which B represents any of the following groups: (—CHR3—N═N—), (—CH═CH—)ₙ or (—CH═N—)ₙ in which groups n-represents an integer of from 1 to 3 and R3 is a substituent group as defined, supra. (It is to be understood that if the above mentioned formula comprises two or more R3-substituent groups, these R3-substituent groups may be the same or different).

As used herein, the ammonium enhancer may be in their cationic form.

In a preferred embodiment R1 is hydrogen.

In another preferred embodiment R1 is hydrogen and R2 is an alcohol (amino alcohol), e.g., ethanol amine.

In a further preferred embodiment the ammonium enhancer is an ammonium salt, i.e. any ammonium salt known in the art: e.g., diammonium sulphate, ammonium chloride, ammonium bromide, or ammonium iodide.

The ammonium enhancer may suitably be present in compositions to which the particle of the invention is applied in a concentration corresponding to an ammonium concentration in the range of from 0.01-1000 millimole/kg, preferably in the range of from 0.05-500 millimole/kg.

Examples on useful Enzyme co-factors are NADH, NADPH, FAD and FADH and small synthetic molecules resembling the function of these.

Examples of useful solvents are water, alcohols, glycerol, MPG, PEG300.

An example of a useful glazing agent is magnesium stearate.

An important feature of the invention is that the enzyme(s) is the only particle component having a detersive properties and that the function of the remaining particle composition is purely to provide desirable physical particle properties or to provide protection, stabilization and/or enhancement of the enzyme(s) or the detersive effect of the enzyme. Accordingly the remaining particle composition has only limited detersive properties and possesses a detergency of less than 4 when measured in the detergency test method as defined herein. Preferably the detergency of the non-enzyme particle composition is less than 2, more preferably less than 1. In accordance with this feature, the particle composition is preferably free of conventional detergent ingredients such as surfactants, e.g. anionic surfactants, bleach, builders, optical brighteners, suds suppressors, pH regulating agents and the like, in amounts rendering detergency of the non-enzyme composition to exceed the detergency limits as defined, supra. It is well known that such compounds, especially certain surfactants and bleach contributes severely to the inactivation of enzymes during storage enzyme containing detergents. Accordingly omitting such detergent components from the particle provides increased enzyme stability. The particle of the invention is thus very different from conventional particulate detergent compositions. Accordingly the particle, in a preferred embodiment, is substantially free of anionic surfactant, i.e. the amount of anionic surfactant present in the particles is less than 10% w/w, preferably less than 5% w/w, more preferably less than 1% w/w.

As mentioned, supra, enzymes are proteins, which are sensitive to the environment in which they present. Accordingly enzymes are usually labile and tend to be inactivated or degraded over time, e.g. by oxidation, heat inactivation (protein denaturing) and/or by reaction with other chemicals. In order to preserve enzymatic catalysis power during storage enzymes in a particle of the invention may suitably be protected from inactivation. This may be achieved by adding enzyme stabilizers to the particle composition as described supra, but for further protection of enzymes, the particle of the invention may also be coated with one or more protective coatings. Accordingly in an important embodiment the invention encompasses a particle coated by one or more protective coating layers. A coating layer may also provide the additional benefit of suppressing formation enzyme dust when handling the finished particle. As mentioned, supra, enzymes are proteins which may cause allergic reactions when exposing it to humans or animals such as by inhalation. By coating the particle of the invention the dust formation may be considerably reduced, thereby increasing the safety, i.e. proving the necessary safety for manual handling of the particle.

Examples of useful particle coatings are: waxes, inorganic minerals such as clays, e.g. kaolin and/or bentonite, or zeolites or silicates, sugars or sugar derivatives, cellulose or derivatives thereof such as HPC, CMC, HPMC etc, PVP, PVA, inorganic salts such as alkali or earth alkali metal salts of chloride, sulphate, carbonate or nitrate and pigments.

Process for Manufacture of the Particle

The present invention also relates to a process for preparing a particle of the invention. In one embodiment the process may comprise firstly, the formation of smaller granules e.g. by

Prilling: in which the active component is suspended in a wax, where after the wax suspension is atomised in cold air (with a temperature below the melting point of the wax).

Extrusion: in which the active component is mixed into the carrier materials, where after the mixture is formed into particles by extrusion.

Granulation: in which the active component and the dry granulation auxiliary agents are agglomerated by use of a granulation liquid, either in a fluid bed or a mixer.

Compaction: in which a mixture of the active component and the granulate ingredients are formed into particles by pressing or compressing with high pressure.

After preparation of the smaller granules these granules are agglomerated into the particles of the invention e.g. by subjecting the granules and optionally auxiliary agents (as described supra) to compression/compaction e.g. between two pistons in a tabletting machine, where upon larger particles are formed.

In another embodiment the particle of the invention is formed by subjecting the ingredients to compression/compaction without a prior granulation.

In a third embodiment the particle of the invention is prepared by enclosing the particle ingredients with or without prior granulation or tabletting in a sealed and dust proof container or package of a water soluble material, such as polymers like gelatine or polyvinylpyrrolidone. Thereby the user do not have to unwrap the particle from a wrapping before use, but may apply the particle and the wrapping directly e.g. to the washing process.

Uses

The particles of the invention may suitably be used for increasing the cleaning performance of a washing solution. Accordingly particles of the invention may suitably be added to wash water alone or in combination with a conventional detergent to obtain an increased cleaning performance, preferably directed towards soiling on textile which is a substrate for the enzyme(s) in the particle. A particularly useful application is found for particles of the invention comprising and oxidoreductases and enhancers. Particles comprising oxidoreductases, preferably laccases, and peroxidases such as haloperoxidases optionally formulated in the particle of the invention together with at least one enhancer, improving the effect of the oxidoreductase, will provide excellent microbial control and antimicrobial system in applications in which the particle is used. Such a particle could for example be advantageously used for killing or inhibiting microbial cells in a washing liquor and/or on the fabrics to be cleaned in a washing process. Accordingly the antimicrobial particle of the invention may be added to a washing processes separately and in individual doses, especially when the laundry is particularly soiled from microbially contaminated soilings or soiling facilitating microbial growth, such as faeces or other human or animal secretions, various foodstuffs and/or organic compositions. This concept may of course also be applied on other objects for which sanitation is desired. Accordingly the invention provides use of a particle of the invention comprising an oxidoreductase and preferably also at least one mediator or enhancer for antimicrobial treatment of an object, preferably a cellulose containing fabric. Also using a combination of different enhancer may provide even more improved sanitation effect as different enhancers may have different effect on different types of microbial cells.

Materials and Methods

Detergency Test

A buffer is prepared by mixing Glycin (Merck art. 4201) with demineralised water in amounts to provide a 0.05 M glycin buffer. pH of the buffer is adjusted to pH 10 with 4 M sodium hydroxide. Ca²⁺ and Mg² in a ratio of 4:1 is added to the buffer in amount providing a water hardness of about 15° dH. A test sample is prepared by mixing a test composition with buffer to make up a 7.15 g/l mixture. 1000 ml of buffer and sample is transferred to separate Terg-o-tometer™ wash containers, where it is heated to 30° C. A 9 by 5 cm EMPA 116 test swatch is added to each container and the swatches are washed in a standard Terg-O-tometer™ for 20 minutes at a speed of 100 RPM. A suitable Terg-O-tometer™ may be that described in U.S. Pat. No. 6,017,871 example 68 from United States Testing Co., Inc., Hoboken, N.J. After wash the swatches are rinsed with cold tap water (Zeeland, Denmark) for 10 minutes and dried. After drying the light remissions of each of the sides of the swatches are measured in a Macbeth Color-Eye 7000 Remission spectrophotometer using a wavelength of 460 nm. The relative remission (AR) is calculated by subtracting the average remission from the swatch washed with buffer from the average remission of the swatch washed with test sample.

### EXAMPLES

The present invention is further illustrated by the working examples described below, which are representative, and not intended to be limiting. One skilled in the art will be capable of selecting other enzymes and particulate additives or methods on the basis of teaching herein.

### Example 1

A 10 kg suspension consisting of 3,5 kg spray dried cellulase enzyme concentrate (Carezyme®, available form Novo Nordisk A/S, Denmark) and 6,5 kg wax (Lutensol 80) was sprayed through a rotating disk into a cooling chamber, where the droplets solidified.

### Example 2

A 10 kg suspension consisting of 4.5 kg spray dried cellulase enzyme concentrate (Carezyme®, available form Novo Nordisk A/S, Denmark) and 5.5 kg PEG 4000 was sprayed through a rotating disk into a cooling chamber, where the droplets solidified.

### Example 3

In a 130 l Lödige mixer 31.7 kg of a powder composition prepared from the following: 4.2 kg of fibrous cellulose (Arbocel BFC200), 2.1 kg of kaolin (Speswhite, English China Clay), 0.7 kg of carbohydrate binder (Avebe W80) and 24.7 kg of finely ground sodium sulphate was sprayed with a composition of 6.0 kg liquid cellulase enzyme concentrate (Carezyme®, available form Novo Nordisk A/S, Denmark), 0.7 kg of carbohydrate binder (Avebe W80) and 1.4 kg of sucrose. The mixture was granulated in the mixer, and subsequently dried in a fluid bed as described in Example 1 in U.S. Pat. No. 4,106,991.

### Example 4

In a 130 l Lödige mixer 44 kg of a powder composition prepared from the following: 0.9 kg spray dried protease enzyme concentrate (Savinase®, Novo Nordisk A/S, Denmark); 0.5 kg of Plasdone XL and 42.6 kg of lactose was sprayed with a solution of 1.0 kg of Kollidon VA 64 dissolved in 4.0 kg isopropanol. The mixture was granulated in the mixer, and subsequently dried in a fluid bed as described in Example 1 in U.S. Pat. No. 4,106,991.

### Example 5

In a fluid bed a granulated powder composition containing 2.1 kg of fibrous cellulose (Arbocel BFC200), 1.0 kg of kaolin (Speswhite, English China Clay), 0.35 kg of carbohydrate binder (Avebe W80) and 12.3 kg of finely ground sodium sulphate was sprayed with a composition of 3.0 kg liquid cellulase enzyme concentrate (Carezyme® concentrate, Novo Nordisk A/S, Denmark) and 0.35 kg of carbohydrate binder (HPMC), whereby a layer of enzyme and binder was deposited on the granulated powder composition.

### Example 6

A 15 kg powder composition prepared from the following:

0.5 kg spray dried protease enzyme concentrate (Savinase®, Novo Nordisk A/S, Denmark), 0.3 kg of carbohydrate (PVP K30), 0.6 kg CMEA, 0.45 kg of binder (yellow dextrin) and 13.2 kg of finely ground sodium chloride was mixed with 1.1 kg of water. The obtained paste was and extruded and subsequently fluid bed dried as described in Example 1 in U.S. Pat. No. 4,106,991.

### Example 7

Particles having size of 20 mm in the longest dimension was prepared by mixing 40 9 of enzyme containing granulates of examples 1-7 with 8 g of bursting agent (Explotabs), 51 g of fibrous material (Avicel 101) and 1 g of magnesium stearate glazing agent. This mixture was formed into 20 mm particles in a Diaf tablet machine.

### Example 8

Particles having size of 20 mm in the longest dimension was prepared by mixing 61 g of enzyme containing granulates of examples 1-7 with 12 g of bursting agent (Explotabs) , 76 g of carbohydrate (Prosolv SMCC 90) and 1 g of magnesium stearate glazing agent. This mixture was formed into tablets in a Diaf tablet machine.

### Example 9

Particles having size of 20 mm in the longest dimension was prepared by mixing 80 g of enzyme containing granulates of examples 1-7 with 15 g of bursting agent (Explotabs) 54 g of carbohydrate (Prosolv SMCC 90) and 1 g of magnesium stearate glazing agent. This mixture was formed into tablets in a Diaf tablet machine.

### Example 10

Particles having size of 20 mm in the longest dimension was prepared by mixing 60 g of enzyme containing granulates of examples 1-7 with 10 g of bursting agent (citric acid), 40 g of carbohydrate (Prosolv SMCC 90) and 0.5 g of magnesium stearate glazing agent. This mixture was formed into tablets in a Diaf tablet machine.

### Example 11

A particle composition of the invention without enzyme activity containing 42.6% w/w PEG 4000 binder, 12.3% w/w Explotabs® bursting agent, 44.2% w/w Prosolv® SMCC 90 carbohydrate and 0.9% w/w Mg-stearate glazing agent was prepared. A test sample, A, was prepared by mixing the composition with detergency test buffer in amounts of 7.15 g composition per liter buffer.

### Example 12

A particle composition of the invention without enzyme activity containing 30.2% w/w PEG 4000 binder, 9.3% w/w Explotabs® bursting agent, 59.3% w/w Avicel® 101 cellulose and 1.2% w/w Mg-stearate glazing agent was prepared.

A test sample, B, was prepared by mixing the composition with detergency test buffer in amounts of 7.15 g composition per liter buffer.

### Example 13

A commercial particle composition without enzyme activity was prepared by crushing commercial detergent tablets into powder (Tandil Tabs, Sample No. sam-1999-00270) . A test sample, C, was prepared by mixing the commercial composition with detergency test buffer in amounts of 7.15 9 composition per liter buffer. Any enzyme activity was inactivated by heating the sample shortly in a microwave oven.

### Example 14

The detergency of samples A, B and C was testes by using the detergency test as disclosed herein. The following detergency results were obtained:

| Sample | Type | Dosage | ΔR |
|---|---|---|---|
| A | non enzyme particle | 7.15 g/l | 0.61 |
| | composition of the invention | | |
| B | non enzyme particle | 7.15 g/l | 0.71 |
| | composition of the invention | | |
| C | commercial non enzyme | 7.15 g/l | 4.31 |
| | particle composition | | |

1. An enzyme containing cleaning particle having a size of more than 10.5 mm in its longest dimension, wherein the non-enzyme components of the particle have a detergency of less than 4.

2. The particle of claim 1, having a size between 10.5 and 50 mm.

3. The particle of claim 1, having a volume of at least 0.5 cm³.

4. The particle of claim 1, having a shape selected from the group consisting of spherical, cylindrical, disc, cubic, rectangular.

5. The particle of claim 1, wherein the enzyme is selected from the group consisting of amylase, cellulase, cutinase lipase, oxidoreductase, and protease.

6. The particle of claim 1, wherein the particle contains between 2 to 50% w/w of enzyme protein.

7. The particle of claim 1, wherein the particle contains between 10 to 50% w/w of enzyme protein.

8. The particle of claim 1, further comprising one or more auxiliary agents selected from the group consisting of fillers, polymers, binders, colorants, fibres, perfumes, liquid agents, bursting agents, enzyme stabilizers, enzyme mediators, enzyme cofactors, enzyme activators, enzyme de-activators, solvents and glazing agents.

9. The particle of claim 1, wherein the particle is coated or wrapped in a sealed and dust proof container made from a water soluble material.

10. The particle of claim 5, wherein the enzyme is an oxidoreductase.

11. The particle of claim 10, wherein the oxidoreductase is a laccase or peroxidase.

12. The particle of claim 11, wherein the peroxidase is a haloperoxidase.

13. The particle of claim 1, further comprising at least one enhancer.

14. The particle of claim 13, comprising at least two enhancers.

15. A method of increasing the cleaning performance of a washing solution, comprising a particle of claim 1 to the washing solution.

16. A method of antimicrobial treatment of an object, comprising applying a particle of claim 10 to the object.

17. The method of claim 16, wherein the object is a cellulose containing fabric.
